(19) United States
(12) Patent Application Publication
(10) Pub. No.: US 2023/0406290 A1
(43) Pub. Date: Dec. 21, 2023

(54) MOVING BODY CONTROL DEVICE, CONTROL METHOD, AND STORAGE MEDIUM

(71) Applicant: HONDA MOTOR CO., LTD., Tokyo (JP)

(72) Inventor: Shota ISHIKAWA, Tokyo (JP)

(73) Assignee: HONDA MOTOR CO., LTD., Tokyo (JP)

(21) Appl. No.: 18/210,950

(22) Filed: Jun. 16, 2023

(30) Foreign Application Priority Data
Jun. 17, 2022 (JP) 2022-098110

(51) Int. Cl. B60W 30/06; B60W 60/00; B60W 30/18

(52) U.S. Cl. CPC B60W 30/06; B60W 60/001; B60W 2552/53; B60W 2554/80; B60W 30/18163

(57) ABSTRACT

A moving body control device includes: an external environment recognition unit configured to acquire recognition data of an external environment including a surrounding area of a moving body; an acquisition unit configured to acquire, based on the recognition data, other moving body information indicating a feature of another moving body in the surrounding area; a determination unit configured to refer to a storage unit that stores parking position data in which a parking position and a feature of a moving body parked at the parking position are associated with each other and determine whether there is a possibility that the other moving body is to be parked at a surrounding parking position; and a control unit configured to perform predetermined control to prevent the moving body from inhibiting parking toward the surrounding parking position based on a determination that there is the possibility.

### CROSS-REFERENCE RELATED ARTS

This application is based on and claims priority under 35 USC 119 from Japanese Patent Application No. 2022-098110 filed on Jun. 17, 2022.

### TECHNICAL FIELD

The present invention relates to a moving body control device, a control method, and a storage medium.

### BACKGROUND ART

In recent years, efforts have been actively made to provide access to a sustainable transportation system in consideration of vulnerable people among traffic participants. In order to implement the above object and further improve safety and convenience of traffic, research and development related to automatic driving techniques and driving assistance techniques are in progress.

For example, JP2016-024705A discloses a technique in which preceding vehicle information including presence or absence of a preceding vehicle and, when there is a preceding vehicle, including a traveling position of the preceding vehicle and a speed of the preceding vehicle is acquired, an offset determination that is a determination as to whether the acquired traveling position of the preceding vehicle is deviated by a predetermined distance or more in a lane width direction with respect to a reference traveling position (hereinafter also referred to as “offset”) is performed, and, when it is determined that there is an offset, it is also determined that there is a high possibility that the preceding vehicle is to be parked into a parking area as compared to a case where it is not determined that there is an offset.

In addition, JP2012-221451A discloses a technique in which, when a front side of a preceding vehicle faces a direction opposite to a direction of a parking area where the preceding vehicle may park, it is determined that the preceding vehicle may move backward and driving assistance of a host vehicle is performed on the assumption that the preceding vehicle is to move backward.

### SUMMARY

In the related art, it is determined that there is a possibility that the preceding vehicle is to be parked (move backward) based on the fact that the preceding vehicle actually performs an operation related to parking (hereinafter, also referred to as a “parking operation”), for example, the traveling position of the preceding vehicle is offset or the front side of the preceding vehicle faces the direction opposite to the direction of the parking area. Therefore, in the related art, it is not possible to perform control on the assumption that the preceding vehicle is to be parked before the preceding vehicle actually starts the parking operation. Therefore, for example, when the parking operation of the preceding vehicle is suddenly started, the host vehicle cannot respond in time, and thus the host vehicle may inhibit parking of the preceding vehicle.

An object of the present invention is to provide a moving body control device, a control method, and a storage medium storing a program capable of performing, before a parking operation of another moving body in a surrounding area of a moving body is actually started, predetermined control for preventing the moving body from inhibiting parking of the other moving body.

According to an aspect of the present disclosure, there is provided a moving body control device including: an external environment recognition unit configured to acquire recognition data of an external environment including a surrounding area of a moving body; an acquisition unit configured to acquire, based on the recognition data of the external environment, other moving body information indicating a feature of another moving body in the surrounding area of the moving body; a determination unit configured to refer to a storage unit that stores parking position data in which a parking position and a feature of a moving body parked at the parking position are associated with each other and determine, based on the other moving body information, whether there is a possibility that the other moving body is to be parked at a surrounding parking position that is a parking position in the surrounding area of the moving body; and a control unit configured to perform predetermined control to prevent the moving body from inhibiting parking toward the surrounding parking position based on a determination that there is the possibility that the other moving body is to be parked at the surrounding parking position.

According to another aspect of the present disclosure, there is provided a control method causing a computer that controls a moving body to execute processing including: acquiring recognition data of an external environment including a surrounding area of the moving body; acquiring, based on the recognition data of the external environment, other moving body information indicating a feature of another moving body in the surrounding area of the moving body; referring to a storage unit that stores parking position data in which a parking position and a feature of a moving body parked at the parking position are associated with each other and determining, based on the other moving body information, whether there is a possibility that the other moving body is to be parked at a surrounding parking position that is a parking position in the surrounding area of the moving body; and performing predetermined control to prevent the moving body from inhibiting parking toward the surrounding parking position based on a determination that there is the possibility that the other moving body is to be parked at the surrounding parking position.

According to another aspect of the present disclosure, there is provided a non-transitory computer-readable storage medium storing a program configured to cause a computer that controls a moving body to execute processing including: acquiring recognition data of an external environment including a surrounding area of the moving body; acquiring, based on the recognition data of the external environment, other moving body information indicating a feature of another moving body in the surrounding area of the moving body; referring to a storage unit that stores parking position data in which a parking position and a feature of a moving body parked at the parking position are associated with each other and determining, based on the other moving body information, whether there is a possibility that the other moving body is to be parked at a surrounding parking position that is a parking position in the surrounding area of the moving body; and performing predetermined control to prevent the moving body from inhibiting parking toward the surrounding parking position based on a determination that there is the possibility that the other moving body is to be parked at the surrounding parking position.

According to the present invention, it is possible to provide a moving body control device, a control method, and a storage medium storing a program capable of performing, before a parking operation of another moving body in a surrounding area of a moving body is actually started, predetermined control for preventing the moving body from inhibiting parking of the other moving body.

### BRIEF DESCRIPTION OF DRAWINGS

FIG. 1 is a block diagram showing a schematic configuration of a vehicle 1 according to an embodiment;

FIG. 2 shows an operation example of the vehicle 1 in a parking lot P when a control unit 32d executes parking position data storage processing;

FIG. 3 shows an operation example of the vehicle 1 in the parking lot P when the control unit 32d executes first deceleration/stop control;

FIG. 4 shows an operation example of the vehicle 1 in the parking lot P when the control unit 32d executes second deceleration/stop control;

FIG. 5 shows an operation example of the vehicle 1 in the parking lot P when the control unit 32d executes lane-changing overtake/non-lane-changing overtake control;

FIG. 6 shows a display example of a touch panel 21 when the control unit 32d executes first notification control;

FIG. 7 shows a display example of the touch panel 21 when the control unit 32d executes second notification control;

FIG. 8 shows a display example of the touch panel 21 when the control unit 32d executes third notification control; and

FIG. 9 is a flow chart showing an example of processing executed by a control device 30.

### DESCRIPTION OF EMBODIMENTS

Hereinafter, an embodiment of a moving body control device, a control method, and a program according to the present invention will be described in detail with reference to the drawings. Hereinafter, an embodiment in which the moving body in the present invention is a vehicle will be described. In the present specification and the like, in order to simplify and clarify the description, directions such as front, rear, left, right, up, and down are described according to directions viewed from a user (for example, a driver) that is an occupant of the vehicle. In addition, in the following description, the same or similar elements are denoted by the same or similar reference numerals, and the description thereof may be omitted or simplified as appropriate.

(Vehicle)

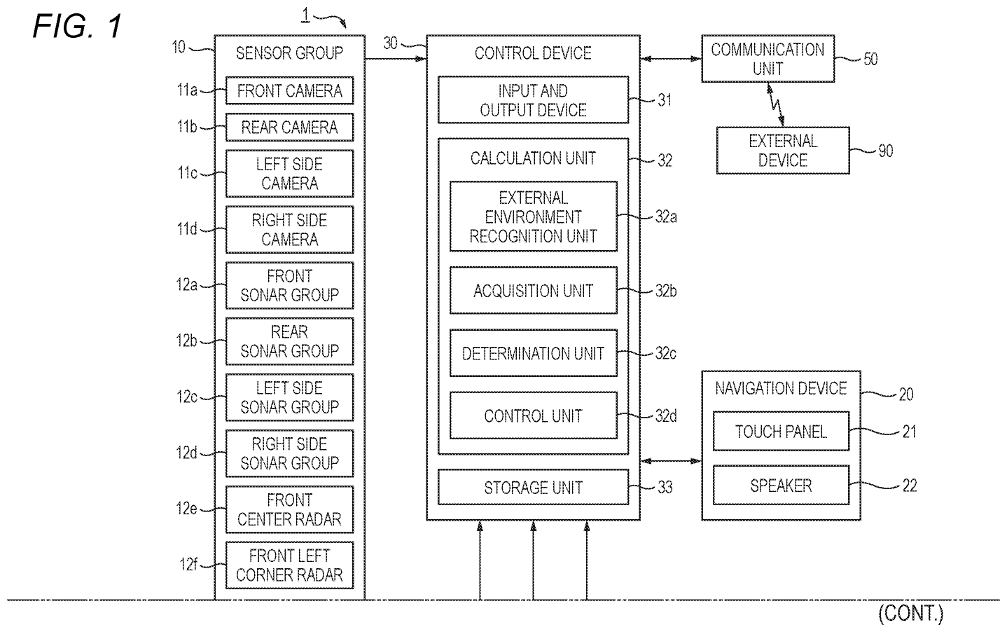

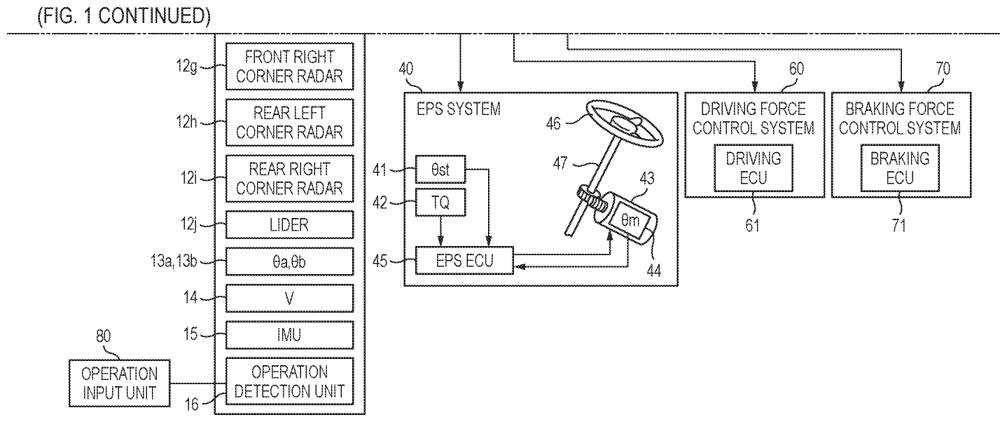

A vehicle 1 according to the present embodiment shown in FIG. 1 (hereinafter, also referred to as “host vehicle 1”) is an automobile including a drive source, and wheels (all not shown) including drive wheels driven by power of the drive source and steerable wheels that are steerable. For example, the vehicle 1 is a four-wheeled automobile including a pair of left and right front wheels and a pair of left and right rear wheels. The drive source of the vehicle 1 may be an electric motor, an internal combustion engine such as a gasoline engine or a diesel engine, or a combination of an electric motor and an internal combustion engine. The drive source of the vehicle 1 may drive the pair of left and right front wheels, the pair of left and right rear wheels, or the four wheels including the pair of left and right front wheels and the pair of left and right rear wheels. The front wheels or the rear wheels may be both steerable wheels that are steerable, or either of the front wheels or of the rear wheel may be a steerable wheel.

The vehicle 1 is configured to be movable by automatic steering toward a target position specified by the user. As the target position, a predetermined parking position (parking space) may be set. That is, the vehicle 1 is capable of being parked by automatic steering at the parking position specified by the user. Parking by the automatic steering at the parking position specified by the user is hereinafter also referred to as “automatic parking”.

As shown in FIG. 1, the vehicle 1 includes a sensor group 10, a navigation device 20, a control device 30, an electric power steering system (EPS system) 40, a communication unit 50, a driving force control system 60, and a braking force control system 70. The control device 30 is an example of a moving body control device.

The sensor group 10 acquires various detection values related to the vehicle 1 or a surrounding area of the vehicle 1. The detection values acquired by the sensor group 10 are transmitted to the control device 30 and used for controlling the vehicle 1 by the control device 30. The sensor group 10 includes, for example, a front camera 11a, a rear camera 11b, a left side camera 11c, a right side camera 11d, a front sonar group 12a, a rear sonar group 12b, a left side sonar group 12c, a right side sonar group 12d, a front center radar 12e, a front left corner radar 12f, a front right corner radar 12g, a rear left corner radar 12h, a rear right corner radar 12i, and a light detection and ranging (LiDAR) 12j. The cameras 11a to 11d, the sonar groups 12a to 12d, the radars 12e to 12i, and the LiDAR 12j may function as external sensors that acquire information on an external environment including the surrounding area of the vehicle 1.

The front camera 11a, the rear camera 11b, the left side camera 11c, and the right side camera 11d output, to the control device 30, image data of surrounding images obtained by capturing images of the surrounding area of the vehicle 1. The surrounding images captured by the front camera 11a, the rear camera 11b, the left side camera 11c, and the right side camera 11d are also referred to as a front image, a rear image, a left side image, and a right side image, respectively. An image formed by the left side image and the right side image is also referred to as a side image.

The front sonar group 12a, the rear sonar group 12b, the left side sonar group 12c, and the right side sonar group 12d emit sound waves to the surrounding area of the vehicle 1 and receive reflected sounds from other objects. The front sonar group 12a includes, for example, four sonars. The sonars constituting the front sonar group 12a are respectively provided on an obliquely left front side, a front left side, a front right side, and an obliquely right front side of the vehicle 1. The rear sonar group 12b includes, for example, four sonars. The sonars constituting the rear sonar group 12b are respectively provided on an obliquely left rear side, a rear left side, a rear right side, and an obliquely right rear side of the vehicle 1. The left side sonar group 12c includes, for example, two sonars. The sonars constituting the left side sonar group 12c are provided in the front of a left side of the vehicle 1 and in the rear of the left side, respectively. The right side sonar group 12d includes, for example, two sonars. The sonars constituting the right side sonar group 12d are provided in the front of a right side of the vehicle 1 and in the rear of the right side, respectively.

The front center radar 12e, the front left corner radar 12f, the front right corner radar 12g, the rear left corner radar 12h, and the rear right corner radar 12i emit radar waves to the surrounding area of the vehicle 1 and receive radar waves reflected by other objects. More specifically, the front center radar 12e is provided at a substantial center of the front side of the vehicle 1, emits radar waves to the front side of the vehicle 1 and receives radar waves reflected by objects located on the front side of the vehicle 1. The front left corner radar 12f is provided on the obliquely left front side of the vehicle 1, emits radar waves to the obliquely left front side of the vehicle 1 and receives radar waves reflected by objects on the obliquely left front side of the vehicle 1. The front right corner radar 12g is provided on the obliquely right front side of the vehicle 1, emits radar waves to the obliquely right front side of the vehicle 1 and receives radar waves reflected by objects located on the obliquely right front side of the vehicle 1. The rear left corner radar 12h is provided on the obliquely left rear side of the vehicle 1, emits radar waves to the obliquely left rear side of the vehicle 1 and receives radar waves reflected by objects located on the obliquely left rear side of the vehicle 1. The rear right corner radar 12i is provided on the obliquely right rear side of the vehicle 1, emits radar waves to the obliquely right rear side of the vehicle 1 and receives radar waves reflected by objects located on the obliquely right rear side of the vehicle 1. The radar wave from the front center radar 12e, the front left corner radar 12f, the front right corner radar 12g, the rear left corner radar 12h, and the rear right corner radar 12i may be, for example, a millimeter wave, and is not limited thereto, and may be, for example, a microwave.

The LiDAR 12j emits a predetermined laser beam to the surrounding area of the vehicle 1, and measures a time required to detect scattered light with respect to the emitted laser beam (emitted light), thereby detecting presence or absence of an object (target) and a distance to another object. Distribution information on the object (target) detected by the LiDAR 12j is transmitted to the control device 30.

The sensor group 10 further includes wheel sensors 13a and 13b, a vehicle speed sensor 14, an inertial measurement device (IMU: inertial measurement unit) 15, and an operation detection unit 16. Each of the wheel sensors 13a and 13b detects a rotation angle of a wheel (not shown) of the vehicle 1. The wheel sensors 13a and 13b may be implemented by angle sensors or may be implemented by displacement sensors. The wheel sensors 13a and 13b output detection pulses to the control device 30 each time the wheels rotate by a predetermined angle. The detection pulses output from the wheel sensors 13a and 13b may be used to calculate the rotation angles and rotation speeds of the wheels. A movement distance of the vehicle 1 may be calculated based on the rotation angles of the wheels. The wheel sensor 13a detects, for example, a rotation angle θa of a left rear wheel. The wheel sensor 13b detects, for example, a rotation angle θb of a right rear wheel.

The vehicle speed sensor 14 detects a travel speed of the vehicle 1 (vehicle body), that is, a vehicle speed V, and outputs the detected vehicle speed V to the control device 30. The vehicle speed sensor 14 detects the vehicle speed V based on, for example, rotation of a countershaft of a transmission.

The inertial measurement device 15 detects angular velocities of the vehicle 1 in a pitch direction, a roll direction, and a yaw direction, and accelerations of the vehicle 1 in a front-rear direction, a left-right direction, and an upper-lower direction, and outputs these detection results to the control device 30. Although an example in which the inertial measurement device 15 is provided is described in the present embodiment, the present invention is not limited thereto. For example, merely an acceleration sensor that detects an acceleration of the vehicle 1 in a predetermined direction or a gyro sensor that detects an angular velocity of the vehicle 1 in a predetermined direction may be provided instead of the inertial measurement device 15.

The operation detection unit 16 detects an operation content performed by the user using an operation input unit 80 and outputs the detected operation content to the control device 30. The operation input unit 80 may include, for example, an operation button that receives an operation for instructing execution of automatic parking.

The navigation device 20 detects a current position of the vehicle 1 by using, for example, a global navigation satellite system (GNSS), and guides the user along a route to a destination. The navigation device 20 includes a storage device (not shown) provided with a map information database.

The navigation device 20 includes a touch panel 21 and a speaker 22. The touch panel 21 functions as an input device that receives input of various types of information to the control device 30 and as a display device controlled by the control device 30. That is, the user can input various commands to the control device 30 via the touch panel 21. In addition, various screens are displayed on the touch panel 21.

The speaker 22 functions as a voice output device that notifies the user of various types of guidance information by voice. For example, during the automatic parking, voice guidance may be performed via the speaker 22. Specifically, when movement by automatic steering toward a parking position specified by the user is started, the start of the movement of the vehicle 1 may be notified by the voice guidance via the speaker 22.

The control device 30 is mounted on the vehicle 1, is communicably connected to other devices mounted on the vehicle 1, and integrally controls the entire vehicle 1 by communicating with the other devices. The control device 30 is implemented by, for example, an ECU including a processor that performs various types of calculation, a storage device including a non-transitory storage medium in which various types of information are stored, and an input and output device that controls input and output of data between inside and outside of the control device 30. The control device 30 may be implemented by one ECU or may be implemented by a plurality of ECUs.

Examples of the other devices connected to the control device 30 (hereinafter also simply referred to as “other devices”) include constituent elements provided in the sensor group 10, an EPS ECU 45 of the EPS system 40, a driving ECU 61 of the driving force control system 60, and a braking ECU 71 of the braking force control system 70. The EPS ECU 45, the driving ECU 61, and the braking ECU 71 will be described later.

The control device 30 and the other devices are connected via, for example, a wired communication network implemented by various wire harnesses, cables, and connectors routed inside the vehicle 1. In addition, for example, a controller area network (CAN), a local interconnect network (LIN), Flex Ray, or a CAN with a flexible data rate (CAN FD) can be adopted for the communication between the control device 30 and the other devices.

The EPS system 40 includes a steering angle sensor 41, a torque sensor 42, an EPS motor 43, a resolver 44, and the EPS electronic control unit (EPS ECU) 45. The steering angle sensor 41 detects a steering angle θm of a steering 46. The torque sensor 42 detects a torque TQ applied to the steering 46.

The EPS motor 43 applies a driving force or a reaction force to a steering column 47 connected to the steering 46, thereby enabling assistance of an operation performed by the driver on the steering 46 and enabling automatic steering at the time of automatic parking. The resolver 44 detects a rotation angle θm of the EPS motor 43. The EPS ECU 45 controls the entire EPS system 40. The EPS ECU 45 includes an input and output unit, a calculation unit, and a storage unit (all not shown).

The communication unit 50 is a communication interface that communicates with an external device 90 provided outside the vehicle 1 under control of the control device 30. That is, the control device 30 can communicate with the external device 90 via the communication unit 50. For example, a mobile communication network such as a cellular line, Wi-Fi (registered trademark), or Bluetooth (registered trademark) may be adopted for the communication between the vehicle 1 and the external device 90. Examples of the external device 90 include a smartphone carried by the user, and a server managed by a manufacturer of the vehicle 1. The server may be a virtual server (cloud server) implemented by cloud computing, or may be a server implemented physically as one device.

The driving force control system 60 includes the driving ECU 61. The driving force control system 60 executes driving force control of the vehicle 1. The driving ECU 61 controls a driving force of the vehicle 1 by controlling an engine or the like (not shown) based on an operation performed on an accelerator pedal (not shown) by the user or an instruction from the control device 30.

The braking force control system 70 includes the braking ECU 71. The braking force control system 70 executes braking force control of the vehicle 1. The braking ECU 71 controls a braking force of the vehicle 1 by controlling a brake mechanism or the like (not shown) based on an operation performed on a brake pedal (not shown) by the user.

(Control Device)

Next, an example of the control device 30 will be described in detail. The control device 30 includes an input and output unit 31, a calculation unit 32, and a storage unit 33. The input and output unit 31 is an interface that inputs and outputs data between inside and outside of the control device 30 under control of the calculation unit 32.

The storage unit 33 includes a non-volatile storage medium, such as a flash memory accessible by the calculation unit 32, and stores various types of information (for example, data and programs) for controlling an operation of the vehicle 1. In addition, the storage unit 33 stores, for example, information indicating a parking position of the host vehicle 1 specified by the user.

The storage unit 33 further stores, for example, parking position data indicating a parking position of another vehicle. Here, the parking position data is information in which the parking position and a feature of the other vehicle parked at the parking position are associated with each other, for example, information indicating where the parking position of the other vehicle with a certain appearance feature (for example, a specific number) is located. The control device 30 (the calculation unit 32) may specify a parking position (a surrounding parking position to be described later) located in the surrounding area of the current position of the vehicle 1 by referring to the parking position data, and acquire information indicating an appearance feature of another vehicle parked at this parking position.

In the present embodiment, as will be described later, the control device 30 (the calculation unit 32) appropriately stores the parking position data in the storage unit 33. However, the present invention is not limited thereto. For example, the parking position data may be prepared by an administrator of a parking lot in which the vehicle 1 is routinely parked, and may be appropriately distributed to the control device 30 via a predetermined network. In addition, the parking position data may be stored in a server accessible by the control device 30 (for example, a server of the administrator of the parking lot in which the vehicle 1 is routinely parked) instead of the storage unit 33. In this case, the control device 30 (the calculation unit 32) may appropriately refer to the parking position data stored in the server.

The calculation unit 32 is implemented by, for example, a processor that performs various types of calculation, such as a central processing unit (CPU), and controls constituent elements of the vehicle 1 by executing programs stored in the storage unit 33. Accordingly, the automatic parking is realized. For example, when an operation that provides an instruction for executing the automatic parking is received via the input and output unit 31, the calculation unit 32 executes the automatic parking.

In addition, the calculation unit 32 includes an external environment recognition unit 32a, an acquisition unit 32b, a determination unit 32c, and a control unit 32d.

The external environment recognition unit 32a acquires recognition data of an external environment including the surrounding area of the host vehicle 1. The recognition data of the external environment includes, for example, image data of the surrounding images captured by the cameras 11a to 11d. More specifically, the recognition data of the external environment may be, for example, data including information indicating an image of an object (for example, another vehicle) in the surrounding area of the vehicle 1, a distance between the vehicle 1 and the object, and a relative position between the vehicle 1 and the object obtained by integrally processing information obtained by two or more types of external sensors among the cameras 11a to 11d, the sonar groups 12a to 12d, the radars 12e to 12i, and the LiDAR 12j (so-called sensor fusion).

The acquisition unit 32b acquires other vehicle information indicating a feature of another vehicle (hereinafter, also referred to as “other vehicle”) in the surrounding area of the vehicle 1 based on the recognition data of the external environment. More specifically, the acquisition unit 32b acquires other vehicle information indicating a feature of another vehicle (hereinafter, also referred to as “preceding vehicle”) traveling ahead of the vehicle 1. In addition, in the present embodiment, the acquisition unit 32b also acquires other vehicle information indicating a feature of another vehicle parked in the surrounding area of the vehicle 1 (for example, a vehicle stopped for a certain period of time).

Here, the other vehicle information is information indicating the appearance feature of the other vehicle, and is information that allows the other vehicle to be identified with a certain degree of accuracy. For example, the other vehicle information may be information indicating a number on a license plate attached to the other vehicle. In this way, by using the other vehicle information as the information indicating the number of the other vehicle, it is possible to improve accuracy of identifying the other vehicle based on the other vehicle information. In addition, the other vehicle information may be information indicating a shape, a color, or a vehicle type of the other vehicle in place of or in addition to the number of the other vehicle. Such other vehicle information can be acquired, for example, by performing image analysis on image data in the recognition data of the external environment. The other vehicle information is an example of other moving body information.

The determination unit 32c refers to the parking position data stored in the storage unit 33 or the like, and determines, based on the other vehicle information acquired by the acquisition unit 32b, whether there is a possibility that the other vehicle is to be parked at a surrounding parking position that is a parking position in the surrounding area of the host vehicle 1. In the present embodiment, the determination unit 32c determines whether there is a possibility that the preceding vehicle is to be parked at the surrounding parking position.

Here, the surrounding parking position may be, for example, a parking position within a predetermined distance from the current position of the host vehicle 1 and facing a passage that forms a route (for example, a route α to be described later) along which the host vehicle 1 is scheduled to travel. By setting such a parking position as the surrounding parking position, it is possible to treat the parking position where the preceding vehicle is highly possible to be parked as the surrounding parking position, and it is possible to appropriately perform inhibition prevention control to be described later. The predetermined distance is set in advance for the control device 30 by, for example, the manufacturer of the vehicle 1 or the control device 30.

For example, the determination unit 32c determines whether an appearance feature of the preceding vehicle coincides with the appearance feature (for example, the number) of the other vehicle associated with the surrounding parking position (for example, a parking position satisfying the condition of the surrounding parking position described above) in the parking position data. When it is determined that the features coincide with each other, the determination unit 32c determines that there is a possibility that the preceding vehicle is to be parked at the surrounding parking position. On the other hand, when it is determined that the features do not coincide with each other, the determination unit 32c determines that there is no possibility that the preceding vehicle is to be parked at the surrounding parking position.

Based on the determination that there is a possibility that the other vehicle is to be parked at the surrounding parking position, the control unit 32d performs predetermined control (hereinafter, also referred to as “inhibition prevention control”) that prevents the host vehicle 1 from inhibiting the parking toward the surrounding parking position. Accordingly, when it is determined that there is a possibility that the other vehicle is to be parked at the surrounding parking position of the host vehicle 1 based on the other vehicle information indicating the feature of the other vehicle in the surrounding area of the host vehicle 1, the control device 30 may perform the inhibition prevention control that prevents the host vehicle 1 from inhibiting the parking toward the surrounding parking position. Therefore, the inhibition prevention control (predetermined control) may be performed before a parking operation of the other vehicle toward the surrounding parking position is actually started, and even when the parking operation is suddenly started, it is possible to prevent the host vehicle 1 from inhibiting the parking of the other vehicle.

In the present embodiment, based on the determination that there is a possibility that the preceding vehicle is to be parked at the surrounding parking position, the control unit 32d performs the inhibition prevention control that prevents the host vehicle 1 from inhibiting the parking of the preceding vehicle toward the surrounding parking position. A specific example of the inhibition prevention control in the present embodiment will be described later, and thus description thereof is omitted here.

In addition, in the present embodiment, when the other vehicle information indicating the feature of the parked other vehicle is acquired, the control unit 32d further performs control (hereinafter referred to as “parking position data storage processing”) of storing, in the storage unit 33, the parking position data in which the parking position of the other vehicle and the feature of the other vehicle are associated with each other. Accordingly, based on the fact that the other vehicle information indicating the feature of the parked other vehicle is acquired, the parking position data in which the parking position of the other vehicle and the feature of the other vehicle are associated with each other may be stored in the storage unit 33. Through such parking position data storage processing, the control device 30 may self-learn (in other words, accumulate) the parking position data.

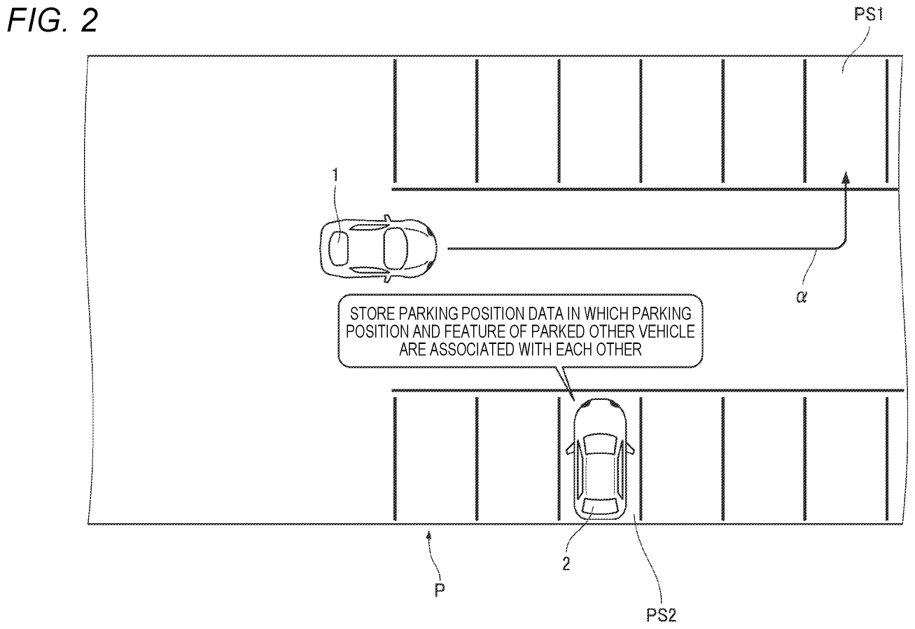

FIG. 2 shows an operation example of the host vehicle 1 in a parking lot P when the control unit 32d executes the parking position data storage processing. The parking lot P shown in FIG. 2 includes a plurality of parking positions (parking spaces) and is a parking lot in which a vehicle parked at each parking position is decided in advance. Examples of the parking lot P of this type include a so-called “monthly parking lot” and a parking lot for a resident of a housing complex such as a condominium or an apartment.

In FIG. 2, a route (hereinafter, also referred to as “route a”) along which the host vehicle 1 travels when the host vehicle 1 is to be automatically parked at a parking position PS1 of the host vehicle 1 is represented by an arrow a. In addition, in the example shown in FIG. 2, another vehicle 2 is parked at a parking position PS2 of the other vehicle 2. The parking position PS2 is a parking position facing a passage forming the route α.

When the other vehicle 2 is parked at the parking position PS2 whereas the host vehicle 1 travels along the route α and is to be automatically parked at the parking position PS1, other vehicle information indicating a feature (for example, a number) of the other vehicle 2 is acquired by the acquisition unit 32b. In this way, based on the fact that the other vehicle information on the other vehicle 2 is acquired, the control unit 32d stores, in the storage unit 33, parking position data in which the parking position PS2 of the other vehicle 2 and the feature of the other vehicle 2 are associated with each other. The parking position PS2 of the other vehicle 2 may be specified based on the recognition data of the external environment, for example.

In this way, the control device 30 self-learns the parking position data related to the parking lot P (for example, the parking lot in which the host vehicle 1 is routinely parked) in which the automatic parking of the host vehicle 1 is performed, so that the control device 30 can perform control such as the inhibition prevention control using the parking position data even when the parking position data is not prepared in advance.

### Specific Example of Inhibition Prevention Control

Next, a specific example of the inhibition prevention control will be described. Hereinafter, the same portions as those shown in FIG. 2 are denoted by the same reference numerals, and description thereof will be omitted or simplified as appropriate. In addition, hereinafter, it is assumed that the parking position data in which the parking position PS2 of the other vehicle 2 and the feature of the other vehicle 2 are associated with each other is stored in the storage unit 33.

The inhibition prevention control may be, for example, control (hereinafter, also referred to as “first deceleration/stop control”) of decelerating or stopping the host vehicle 1 such that a distance between the host vehicle 1 and another vehicle (for example, a preceding vehicle) is maintained at a predetermined value or more.

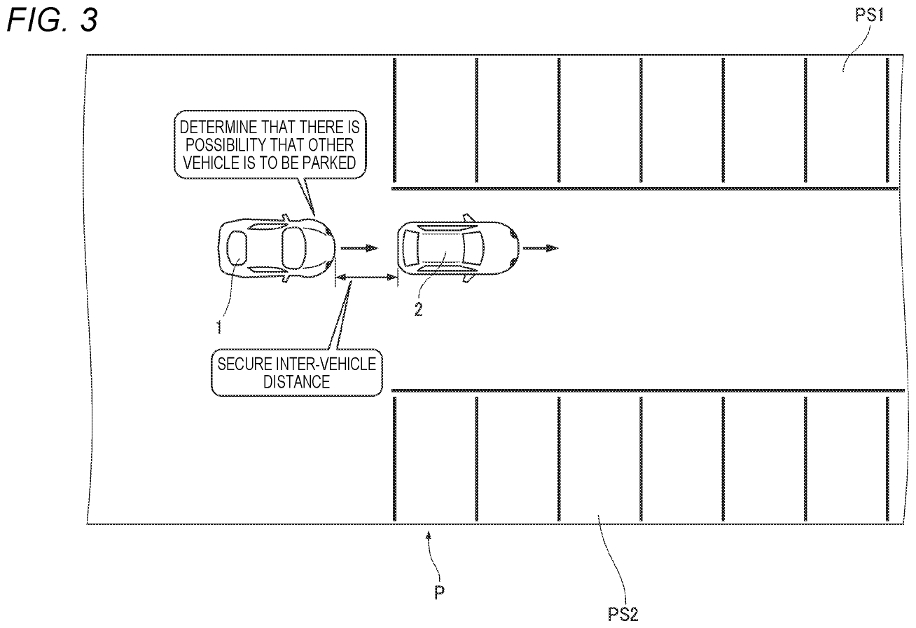

FIG. 3 shows an operation example of the host vehicle 1 in the parking lot P when the control unit 32d executes the first deceleration/stop control. FIG. 3 shows a situation in which the other vehicle 2 travels ahead of the host vehicle 1 that is traveling in the parking lot P so as to be parked automatically at the parking position PS1.

In such a case, when the other vehicle information indicating the feature (for example, the number) of the other vehicle 2 is acquired by the acquisition unit 32b, the determination unit 32c determines that there is a possibility that the other vehicle 2 is to be parked at the parking position PS2 that is the surrounding parking position, and the first deceleration/stop control is performed by the control unit 32d as the inhibition prevention control. When the first deceleration/stop control is performed in this way, the control device decelerates or stops the host vehicle 1 such that an inter-vehicle distance between the host vehicle 1 and the other vehicle 2 is larger than a normal inter-vehicle distance (for example, a predetermined inter-vehicle distance that is set when it is determined that there is no possibility that the other vehicle 2 is to be parked at the surrounding parking position). Accordingly, even when a parking operation of the other vehicle 2 is suddenly performed, it is possible to prevent the host vehicle 1 from inhibiting parking of the other vehicle 2.

In addition, the inhibition prevention control may be control (hereinafter, also referred to as “second deceleration/stop control”) of decelerating or stopping the host vehicle 1 such that the host vehicle 1 does not enter a predetermined range based on the surrounding parking position.

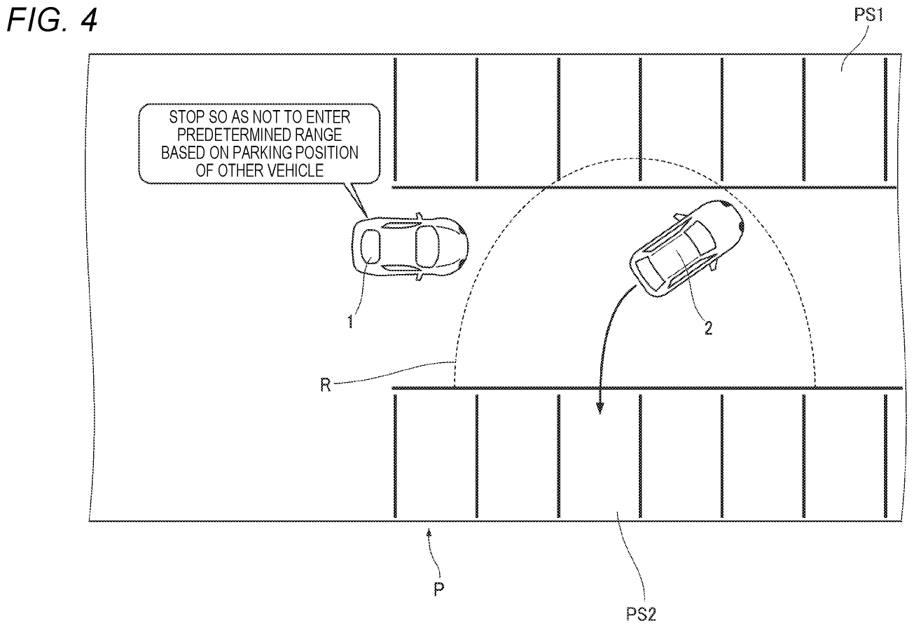

FIG. 4 shows an operation example of the host vehicle 1 in the parking lot P when the control unit 32d executes the second deceleration/stop control. FIG. 4 shows a situation in which the traveling other vehicle 2 and the surrounding parking position, that is, the parking position PS2 of the other vehicle 2 are ahead of the host vehicle 1 that is traveling in the parking lot P so as to be parked automatically at the parking position PS1.

In such a case, when the other vehicle information indicating the feature (for example, the number) of the other vehicle 2 is acquired by the acquisition unit 32b, the determination unit 32c determines that there is a possibility that the other vehicle 2 is to be parked at the parking position PS2 that is the surrounding parking position, and the second deceleration/stop control is performed by the control unit 32d as the inhibition prevention control. When the second deceleration/stop control is performed in this way, the control device 30 decelerates or stops the host vehicle 1 such that the host vehicle 1 does not enter a predetermined range R based on the parking position PS2 of the other vehicle 2. Accordingly, it is possible to prevent the host vehicle 1 from inhibiting parking of the other vehicle 2. The predetermined range R is set in advance for the control device 30 by, for example, the manufacturer of the vehicle 1 or the control device 30.

In addition, the control device 30 may perform both the first deceleration/stop control and the second deceleration/stop control. In this way, for example, it is possible to cause the host vehicle 1 to travel while securing the inter-vehicle distance to the other vehicle 2 until the host vehicle 1 arrives at a position immediately before the predetermined range R based on the parking position PS2 of the other vehicle 2 (see FIG. 3), and to stop the host vehicle 1 (see FIG. 4) when the host vehicle 1 reaches the position immediately before the predetermined range R.

In addition, the inhibition prevention control may be control (hereinafter also referred to as “lane-changing overtake/non-lane-changing overtake control”) of causing the host vehicle 1 to overtake another vehicle (for example, a preceding vehicle) with or without lane change. More specifically, for example, when a predetermined yield operation (for example, lighting of a hazard lamp) of the preceding vehicle is detected based on the recognition data of the external environment, the control unit 32d may perform the lane-changing overtake/non-lane-changing overtake control as the inhibition prevention control.

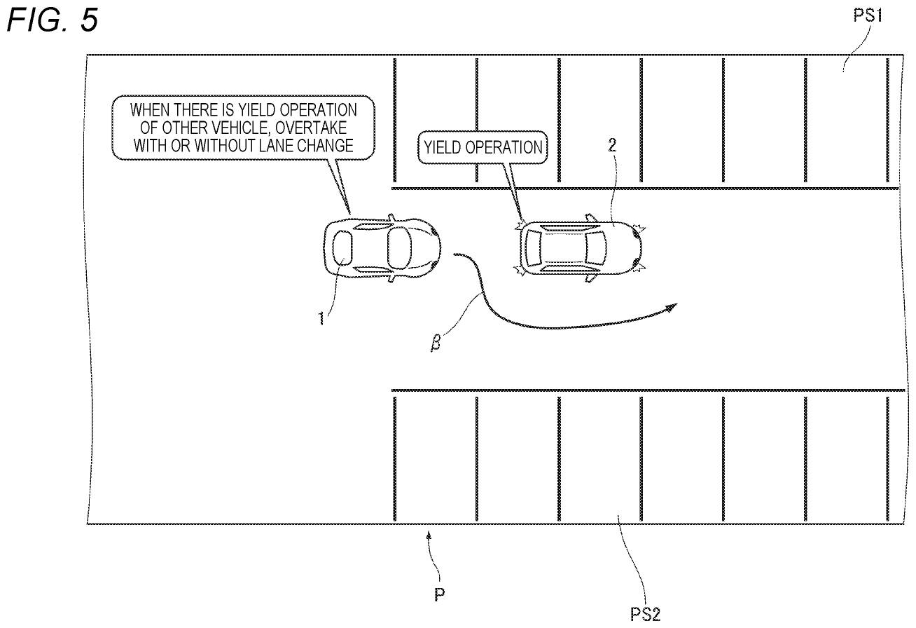

FIG. 5 shows an operation example of the host vehicle 1 in the parking lot P when the control unit 32d executes the lane-changing overtake/non-lane-changing overtake control. FIG. 5 shows a situation in which the other vehicle 2 is ahead of the host vehicle 1 that is traveling in the parking lot P to be parked automatically at the parking position PS1, and the other vehicle 2 performs the predetermined yield operation (for example, lighting of a hazard lamp).

In such a case, when the other vehicle information indicating the feature (for example, the number) of the other vehicle 2 is acquired by the acquisition unit 32b, the determination unit 32c determines that there is a possibility that the other vehicle 2 is to be parked at the parking position PS2 that is the surrounding parking position, and further, the yield operation of the other vehicle 2 is also detected. Accordingly, the lane-changing overtake/non-lane-changing overtake control is performed by the control unit 32d as the inhibition prevention control.

In the example shown in FIG. 5, since the host vehicle 1 is in a same lane as the other vehicle 2, when the lane-changing overtake/non-lane-changing overtake control is performed, the control unit 32d changes a course of the host vehicle 1 as indicated by an arrow (3 in FIG. 5, and causes the host vehicle 1 to perform a series of operations (that is, a lane-changing overtake operation) to pass beside the other vehicle 2 and go ahead of the other vehicle 2.

On the other hand, if the host vehicle 1 is not in a same lane but is offset in a vehicle width direction with respect to the other vehicle 2, when the lane-changing overtake/non-lane-changing overtake control is performed, the control unit 32d causes the host vehicle 1 to perform a series of operations (that is, a non-lane-changing overtake operation) to pass beside the other vehicle 2 and go ahead of the other vehicle 2 without changing the course of the host vehicle 1.

In this way, the control device 30 enables the host vehicle 1 to quickly leave the other vehicle 2 by performing the lane-changing overtake/non-lane-changing overtake control. Accordingly, it is possible to prevent the host vehicle 1 from inhibiting parking of the other vehicle 2.

In each example of the inhibition prevention control described above, it is assumed that the host vehicle 1 travels by automatic parking (that is, automatic steering). Hereinafter, a specific example of the inhibition prevention control that can be performed in a situation in which the host vehicle 1 travels by manual driving will be described. Hereinafter, the same portions as those shown in FIGS. 2 to 5 are denoted by the same reference numerals, and description thereof will be omitted or simplified as appropriate.

The inhibition prevention control may be, for example, control (hereinafter, also referred to as “first notification control”) of notifying the user of the host vehicle 1 such that a distance between the host vehicle 1 and another vehicle (for example, a preceding vehicle) is maintained at a predetermined value or more.

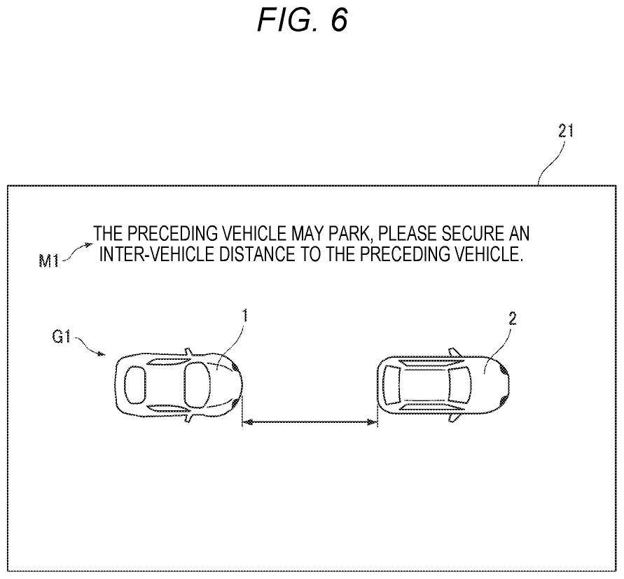

FIG. 6 shows a display example of the touch panel 21 when the control unit 32d executes the first notification control. The first notification control is executed, for example, in place of the first deceleration/stop control shown in FIG. 3 when the user is to park the host vehicle 1 at the parking position PS1 manually. That is, in a case where the user is to park the host vehicle 1 to the parking position PS1 manually, when the situation shown in FIG. 3 occurs, the first notification control is executed, and a display screen shown in FIG. 6 is displayed on the touch panel 21.

Specifically, in the example shown in FIG. 6, a message M1 “the preceding vehicle may be parked, please secure an inter-vehicle distance to the preceding vehicle” is displayed on the touch panel 21 by the first notification control together with an image G1 indicating a situation in which the other vehicle 2 is ahead of the host vehicle 1. By executing such first notification control, the control device 30 may prompt the user to secure the distance between the host vehicle 1 and the other vehicle 2, and thus may prevent the host vehicle 1 from inhibiting parking of the other vehicle 2.

In addition, the inhibition prevention control may be control (hereinafter, also referred to as “second notification control”) of notifying the user of the host vehicle 1 such that the host vehicle 1 does not enter the predetermined range based on the surrounding parking position.

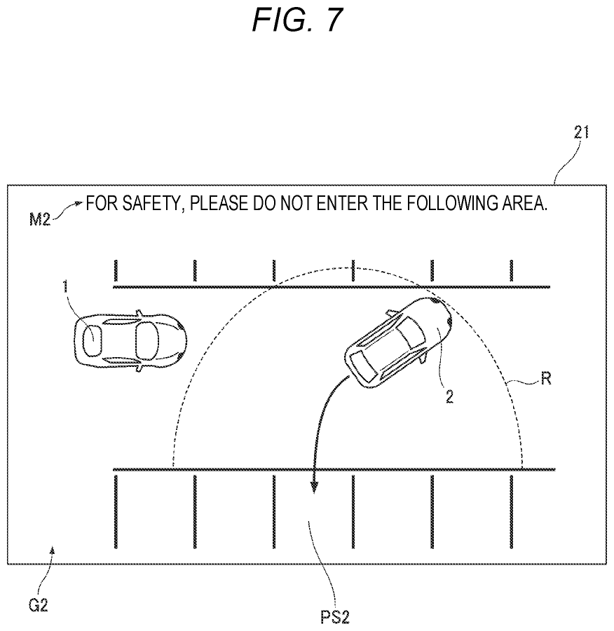

FIG. 7 shows a display example of the touch panel 21 when the control unit 32d executes the second notification control. The second notification control is executed, for example, in place of the second deceleration/stop control shown in FIG. 4 when the user is to park the host vehicle 1 to the parking position PS1 manually. That is, in a case where the user is to park the host vehicle 1 at the parking position PS1 manually, when the situation shown in FIG. 4 occurs, the second notification control is executed, and a display screen shown in FIG. 7 is displayed on the touch panel 21.

Specifically, in the example shown in FIG. 7, a message M2 “for safety, please do not enter the following area” is displayed on the touch panel 21 together with a top view image G2 indicating the other vehicle 2 ahead of the host vehicle 1 and an area (predetermined range R) where the other vehicle 2 may travel along with a parking operation of the other vehicle 2 toward the parking position PS2. By executing such second notification control, the control device 30 may prompt the user to prevent the host vehicle 1 from entering the predetermined range R based on the parking position PS2 of the other vehicle 2, and thus may prevent the host vehicle 1 from inhibiting parking of the other vehicle 2 to the parking position PS2.

In addition, the inhibition prevention control may be control (hereinafter, also referred to as “third notification control”) of notifying the user of the host vehicle 1 such that the host vehicle 1 overtakes the other vehicle 2 with or without lane change.

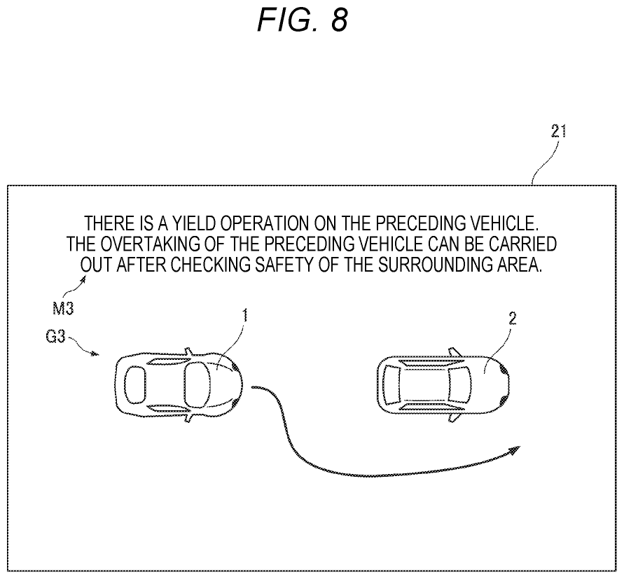

FIG. 8 shows a display example of the touch panel 21 when the control unit 32d executes the third notification control. The third notification control is executed in place of the lane-changing overtake/non-lane-changing overtake control shown in FIG. 5 when the user is to park the host vehicle 1 to the parking position PS1 manually. That is, in a case where the user manually parks the host vehicle 1 to the parking position PS1, when the situation shown in FIG. 5 occurs, the third notification control is executed, and a display screen shown in FIG. 8 is displayed on the touch panel 21.

Specifically, in the example shown in FIG. 8, a message M3 “There is a yield operation on the preceding vehicle. The overtaking of the preceding vehicle can be carried out after checking safety of the surrounding area” is displayed on the touch panel 21 together with an image G3 indicating the lane-changing overtake operation performed by the host vehicle 1 with respect to the other vehicle 2. By executing such third notification control, the control device 30 may prompt the user of the host vehicle 1 to overtake the other vehicle 2 with or without lane change so as to quickly leave the other vehicle 2, and thus may prevent the host vehicle 1 from inhibiting parking of the other vehicle 2.

### Example of Processing Executed by Control Device

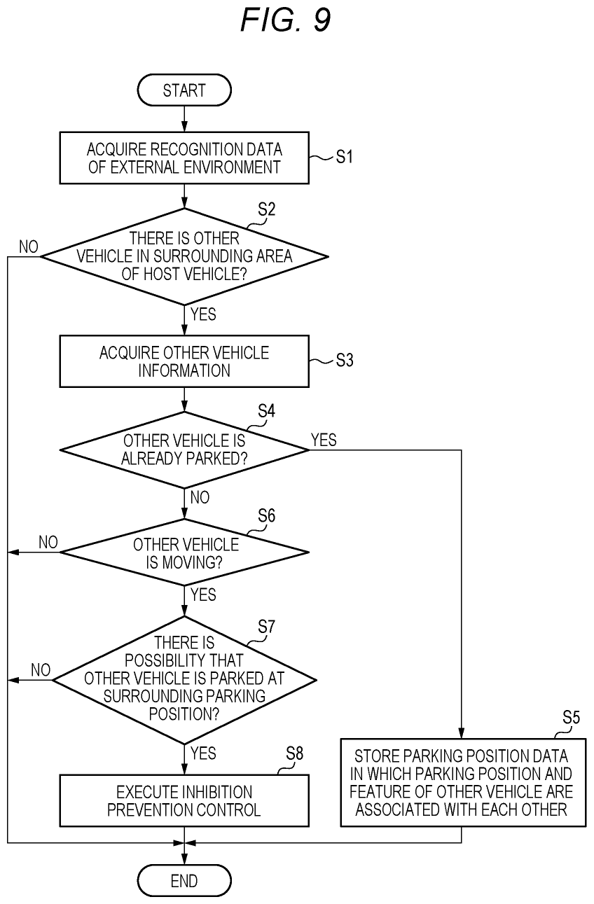

Next, an example of processing executed by the control device 30 will be described with reference to FIG. 9. When activated, the control device 30 repeatedly executes, for example, a series of processing shown in FIG. 9 at a predetermined cycle. In addition, for example, the control device 30 may execute the processing shown in FIG. 9 when it is detected that the host vehicle 1 enters a parking lot in which the host vehicle 1 is routinely parked, such as the parking lot P, or may execute the processing shown in FIG. 9 when an operation instructing execution of automatic parking is performed. Alternatively, the control device 30 may execute the processing shown in FIG. 9 when it is detected that parking of the host vehicle 1 toward a predetermined parking position is about to be performed, regardless of whether the parking is automatic parking or manual parking.

As shown in FIG. 9, first, the control device 30 acquires the recognition data of the external environment including the surrounding area of the host vehicle 1 (step S1). Next, the control device 30 determines whether there is any other vehicle in the surrounding area of the host vehicle 1 (step S2). If it is determined that there is another vehicle in the surrounding area of the host vehicle 1 (step S2: Yes), the control device 30 acquires other vehicle information indicating a feature of the other vehicle (step S3).

Next, the control device 30 determines whether the other vehicle is already parked (step S4). If it is determined that the other vehicle is already parked (step S4: Yes), the control device 30 stores, in the storage unit 33, parking position data in which a parking position of the other vehicle and the feature of the other vehicle are associated with each other (step S5), and ends the series of processing shown in FIG. 9.

On the other hand, if it is determined that the other vehicle is not already parked (step S4: No), the control device 30 determines whether the other vehicle is moving (traveling) (step S6). If it is determined that the other vehicle 2 is moving (step S6: Yes), the control device 30 determines whether there is a possibility that the other vehicle is to be parked at a surrounding parking position of the host vehicle 1 (step S7).

Then, if it is determined that there is a possibility that the other vehicle is to be parked at the surrounding parking position of the host vehicle 1 (step S7: Yes), the control device 30 executes the inhibition prevention control as the predetermined control (step S8), and ends the series of processing shown in FIG. 9.

As described above, when it is determined that there is a possibility that the other vehicle is to be parked at the surrounding parking position of the host vehicle 1, the control device 30 executes the inhibition prevention control as the predetermined control for preventing the host vehicle 1 from inhibiting parking of the other vehicle toward the surrounding parking position. Accordingly, the inhibition prevention control may be performed before a parking operation of the other vehicle toward the surrounding parking position is actually started, and even when the parking operation is suddenly started, it is possible to prevent the host vehicle 1 from inhibiting the parking of the other vehicle.

A control method of the control device 30 described in the above embodiment may be implemented by executing a program prepared in advance by a computer (processor). The program is stored in a computer-readable storage medium and executed by being read from the storage medium. In addition, the program may be provided in a form stored in a non-transitory storage medium such as a flash memory, or may be provided via a network such as the Internet. In addition, the computer that executes the program may be, for example, a computer provided in the control device 30 (for example, a CPU provided in the control device 30), and is not limited thereto, and may be provided in another device (for example, a server) capable of communicating with the control device 30.

Although the embodiment of the present invention is described above with reference to the accompanying drawings, it is needless to say that the present invention is not limited to such an embodiment. It is apparent that those skilled in the art can conceive of various modifications and alterations within the scope described in the claims, and it is understood that such modifications and alterations naturally fall within the technical scope of the present invention. In addition, the respective constituent elements in the above embodiment may be combined as desired without departing from the gist of the invention.

For example, in the above embodiment, by executing the first notification control, the second notification control, or the third notification control, an image of a predetermined content is displayed on the touch panel 21 to notify the user of the host vehicle 1. Instead of or in addition to the display by the touch panel 21, a voice output of a predetermined content from the speaker 22 may also be employed to notify the user of the host vehicle 1.

In addition, in the above embodiment, an example in which the moving body control device according to the present invention is implemented by the control device 30 provided in the vehicle 1 is described, but the present invention is not limited thereto. For example, a part or all of functional units of the control device 30 described above may be implemented by a server capable of communicating with the control device 30. That is, the moving body control device according to the present invention may be implemented by a server device capable of communicating with the control device 30 provided in the vehicle 1.

In addition, the server may be a virtual server (cloud server) implemented in cloud computing, or may be a physical server implemented as one device.

In addition, in the above embodiment, an example is described in which the moving body in the present invention is the vehicle 1 that is a four-wheeled automobile, but the present invention is not limited thereto. The moving body in the present invention may also be a two-wheeled automobile (so-called motorcycle), a ship or an aircraft.

In the present specification, at least the following matters are described. Although corresponding constituent elements and the like in the above embodiment are shown in parentheses, the present invention is not limited thereto.
(1) A moving body control device (control device 30) including:
an external environment recognition unit (external environment recognition unit 32a) configured to acquire recognition data of an external environment including a surrounding area of a moving body (vehicle 1);
an acquisition unit (acquisition unit 32b) configured to acquire, based on the recognition data of the external environment, other moving body information (other vehicle information) indicating a feature of another moving body (other vehicle 2) in the surrounding area of the moving body;
a determination unit (determination unit 32c) configured to refer to a storage unit (storage unit 33) that stores parking position data in which a parking position and a feature of a moving body parked at the parking position are associated with each other and determine, based on the other moving body information, whether there is a possibility that the other moving body is to be parked at a surrounding parking position (parking position PS2) that is a parking position in the surrounding area of the moving body; and
a control unit (control unit 32d) configured to perform predetermined control to prevent the moving body from inhibiting parking toward the surrounding parking position based on a determination that there is the possibility that the other moving body is to be parked at the surrounding parking position.

According to (1), when it is determined that there is a possibility that the other moving body is to be parked at the surrounding parking position of the moving body based on the other moving body information indicating the feature of the other moving body in the surrounding area of the moving body, the predetermined control may be performed to prevent the moving body from inhibiting the parking toward the surrounding parking position. Accordingly, since the predetermined control may be performed before a parking operation of the other moving body toward the surrounding parking position is actually started, it is possible to prevent the moving body from inhibiting the parking of the other moving body even when the parking operation is suddenly started.
(2) The moving body control device according to (1), in which
the predetermined control is control of decelerating or stopping the moving body such that a distance between the moving body and the other moving body is maintained at a predetermined value or more.

According to (2), since the control of decelerating or stopping the moving body such that the distance between the moving body and the other moving body is maintained at the predetermined value or more is performed as the predetermined control, it is possible to secure the distance between the moving body and the other moving body and thus prevent the moving body from inhibiting parking of the other moving body.
(3) The moving body control device according to (1), in which
the predetermined control is control of decelerating or stopping the moving body such that the moving body does not enter a predetermined range (predetermined range R) based on the surrounding parking position.

According to (3), since the control of decelerating or stopping the moving body such that the moving body does not enter the predetermined range based on the surrounding parking position is performed as the predetermined control, it is possible to prevent the moving body from inhibiting parking toward the surrounding parking position.
(4) The moving body control device according to (1), in which
the predetermined control is control of causing the moving body to overtake the other moving body with or without lane change.

According to (4), since the control of causing the moving body to overtake the other moving body with or without lane change is performed as the predetermined control, it is possible to quickly separate the moving body from the other moving body, and thus it is possible to prevent the moving body from inhibiting parking of the other moving body.
(5) The moving body control device according to (1), in which
the predetermined control is control of notifying a user of the moving body such that a distance between the moving body and the other moving body is maintained at a predetermined value or more.

According to (5), since the control of notifying the user of the moving body such that the distance between the moving body and the other moving body is maintained at the predetermined value or more is performed as the predetermined control, it is possible to prompt the user to secure the distance between the moving body and the other moving body, and thus it is possible to prevent the moving body from inhibiting parking of the other moving body.
(6) The moving body control device according to (1), in which
the predetermined control is control of notifying a user of the moving body such that the moving body does not enter a predetermined range based on the surrounding parking position.

According to (6), since the control of notifying the user of the moving body such that the moving body does not enter the predetermined range based on the surrounding parking position is performed as the predetermined control, it is possible to prompt the user to prevent the moving body from entering the predetermined range, and thus it is possible to prevent the moving body from inhibiting parking toward the surrounding parking position.
(7) The moving body control device according to (1), in which
the predetermined control is control of notifying a user of the moving body to overtake the other moving body with or without lane change.

According to (7), since the control of notifying the user of the moving body to overtake the other moving body with or without lane change is performed as the predetermined control, it is possible to prompt the user to quickly make the moving body leave the other moving body, and thus it is possible to prevent the moving body from inhibiting parking of the other moving body.
(8) The moving body control device according to any one of (1) to (7), in which
the control unit further performs control to store, in the storage unit when the other moving body information indicating the feature of the other moving body being parked is acquired, the parking position data in which the parking position of the other moving body and the feature of the other moving body are associated with each other.

According to (8), it is possible to store, in the storage unit, the parking position data in which the parking position of the other moving body and the feature of the other moving body are associated with each other based on the fact that the other moving body information indicating the feature of the parked other moving body is acquired.
(9) A control method causing a computer that controls a moving body to execute processing including:
acquiring recognition data of an external environment including a surrounding area of the moving body;
acquiring, based on the recognition data of the external environment, other moving body information indicating a feature of another moving body in the surrounding area of the moving body;
referring to a storage unit that stores parking position data in which a parking position and a feature of a moving body parked at the parking position are associated with each other and determining, based on the other moving body information, whether there is a possibility that the other moving body is to be parked at a surrounding parking position that is a parking position in the surrounding area of the moving body; and
performing predetermined control to prevent the moving body from inhibiting parking toward the surrounding parking position based on a determination that there is the possibility that the other moving body is to be parked at the surrounding parking position.

According to (9), when it is determined that there is a possibility that the other moving body is to be parked at the surrounding parking position of the moving body based on the other moving body information indicating the feature of the other moving body in the surrounding area of the moving body, the predetermined control can be performed to prevent the moving body from inhibiting the parking toward the surrounding parking position. Accordingly, since the predetermined control may be performed before a parking operation of the other moving body toward the surrounding parking position is actually started, it is possible to prevent the moving body from inhibiting the parking of the other moving body even when the parking operation is suddenly started.
(10) A non-transitory computer-readable storage medium storing a program configured to cause a computer that controls a moving body to execute processing including:
acquiring recognition data of an external environment including a surrounding area of the moving body;
acquiring, based on the recognition data of the external environment, other moving body information indicating a feature of another moving body in the surrounding area of the moving body;
referring to a storage unit that stores parking position data in which a parking position and a feature of a moving body parked at the parking position are associated with each other and determining, based on the other moving body information, whether there is a possibility that the other moving body is to be parked at a surrounding parking position that is a parking position in the surrounding area of the moving body; and
performing predetermined control to prevent the moving body from inhibiting parking toward the surrounding parking position based on a determination that there is the possibility that the other moving body is to be parked at the surrounding parking position. According to (10), when it is determined that there is a possibility that the other moving body is to be parked at the surrounding parking position of the moving body based on the other moving body information indicating the feature of the other moving body in the surrounding area of the moving body, the predetermined control may be performed to prevent the moving body from inhibiting the parking toward the surrounding parking position. Accordingly, since the predetermined control may be performed before a parking operation of the other moving body toward the surrounding parking position is actually started, it is possible to prevent the moving body from inhibiting the parking of the other moving body even when the parking operation is suddenly started.

What is claimed is:

1. A moving body control device comprising:
an external environment recognition unit configured to acquire recognition data of an external environment including a surrounding area of a moving body;
an acquisition unit configured to acquire, based on the recognition data of the external environment, other moving body information indicating a feature of another moving body in the surrounding area of the moving body;
a determination unit configured to refer to a storage unit that stores parking position data in which a parking position and a feature of a moving body parked at the parking position are associated with each other and determine, based on the other moving body information, whether there is a possibility that the other moving body is to be parked at a surrounding parking position that is a parking position in the surrounding area of the moving body; and
a control unit configured to perform predetermined control to prevent the moving body from inhibiting parking toward the surrounding parking position based on a determination that there is the possibility that the other moving body is to be parked at the surrounding parking position.

2. The moving body control device according to claim 1, wherein
the predetermined control is control of decelerating or stopping the moving body such that a distance between the moving body and the other moving body is maintained at a predetermined value or more.

3. The moving body control device according to claim 1, wherein
the predetermined control is control of decelerating or stopping the moving body such that the moving body does not enter a predetermined range based on the surrounding parking position.

4. The moving body control device according to claim 1, wherein
the predetermined control is control of causing the moving body to overtake the other moving body with or without lane change.

5. The moving body control device according to claim 1, wherein
the predetermined control is control of notifying a user of the moving body such that a distance between the moving body and the other moving body is maintained at a predetermined value or more.

6. The moving body control device according to claim 5, wherein
the predetermined control is control of notifying a user of the moving body such that the moving body does not enter a predetermined range based on the surrounding parking position.

7. The moving body control device according to claim 6, wherein
the predetermined control is control of notifying a user of the moving body to overtake the other moving body with or without lane change.

8. The moving body control device according to claim 7, wherein
the control unit further performs control to store, in the storage unit when the other moving body information indicating the feature of the other moving body being parked is acquired, the parking position data in which the parking position of the other moving body and the feature of the other moving body are associated with each other.

9. The moving body control device according to claim 2, wherein
the control unit further performs control to store, in the storage unit when the other moving body information indicating the feature of the other moving body being parked is acquired, the parking position data in which the parking position of the other moving body and the feature of the other moving body are associated with each other.

10. The moving body control device according to claim 3, wherein
the control unit further performs control to store, in the storage unit when the other moving body information indicating the feature of the other moving body being parked is acquired, the parking position data in which the parking position of the other moving body and the feature of the other moving body are associated with each other.

11. The moving body control device according to claim 4, wherein
the control unit further performs control to store, in the storage unit when the other moving body information indicating the feature of the other moving body being parked is acquired, the parking position data in which the parking position of the other moving body and the feature of the other moving body are associated with each other.

12. The moving body control device according to claim 5, wherein
the control unit further performs control to store, in the storage unit when the other moving body information indicating the feature of the other moving body being parked is acquired, the parking position data in which the parking position of the other moving body and the feature of the other moving body are associated with each other.

13. The moving body control device according to claim 6, wherein
the control unit further performs control to store, in the storage unit when the other moving body information indicating the feature of the other moving body being parked is acquired, the parking position data in which the parking position of the other moving body and the feature of the other moving body are associated with each other.

14. The moving body control device according to claim 7, wherein
the control unit further performs control to store, in the storage unit when the other moving body information indicating the feature of the other moving body being parked is acquired, the parking position data in which the parking position of the other moving body and the feature of the other moving body are associated with each other.

15. A control method causing a computer that controls a moving body to execute processing comprising:
acquiring recognition data of an external environment including a surrounding area of the moving body;
acquiring, based on the recognition data of the external environment, other moving body information indicating a feature of another moving body in the surrounding area of the moving body;
referring to a storage unit that stores parking position data in which a parking position and a feature of a moving body parked at the parking position are associated with each other and determining, based on the other moving body information, whether there is a possibility that the other moving body is to be parked at a surrounding parking position that is a parking position in the surrounding area of the moving body; and
performing predetermined control to prevent the moving body from inhibiting parking toward the surrounding parking position based on a determination that there is the possibility that the other moving body is to be parked at the surrounding parking position.

16. A non-transitory computer-readable storage medium storing a program configured to cause a computer that controls a moving body to execute processing comprising:
acquiring recognition data of an external environment including a surrounding area of the moving body;
acquiring, based on the recognition data of the external environment, other moving body information indicating a feature of another moving body in the surrounding area of the moving body;
referring to a storage unit that stores parking position data in which a parking position and a feature of a moving body parked at the parking position are associated with each other and determining, based on the other moving body information, whether there is a possibility that the other moving body is to be parked at a surrounding parking position that is a parking position in the surrounding area of the moving body; and
performing predetermined control to prevent the moving body from inhibiting parking toward the surrounding parking position based on a determination that there is the possibility that the other moving body is to be parked at the surrounding parking position.
